(19) United States
(12) Patent Application Publication
(10) Pub. No.: US 2004/0088090 A1
(43) Pub. Date: May 6, 2004

(54) System for reading vehicle accident information using telematics system

(76) Inventor: Sung-Don Wee, Seongnam-si (KR)

Correspondence Address: David Tichane, 979 Pinto Palm Terrace, #24, Sunnyvale, CA, 94087, US

(21) Appl. No.: 10/634,375

(22) Filed: Aug. 4, 2003

(30) Foreign Application Priority Data
Nov. 5, 2002 (KR) 2002-68046

(51) Int. Cl. G06F 19/00

(52) U.S. Cl. 701/35; 701/213; 340/438

(57) ABSTRACT

There is provided a system for reading the information about subject vehicles involved in a vehicle accident, and the circumstances of the accident site using a telematics system. The reading system includes: a collision sensing unit operating when a collision of a greater intensity than a predetermined level occurs, and outputting the data; a video camera for photographing the vehicles and circumstances around the collision; a speed detecting unit for detecting the speed of the vehicles; a steering wheel information detecting unit for detecting steering wheel information of the vehicles; a telematics control unit for outputting information of the vehicle to the other vehicle, receiving vehicle information outputted from the other vehicle, storing the vehicle information in a data storing part, calculating moving traces of the vehicles after the collision; an electronic map display unit for displaying current location of the vehicles; and a GPS data receiving/transmitting unit for transmitting the circumstances information to a service center and an insurance company.

### BACKGROUND OF THE INVENTION

1. Field of the Invention

The present invention relates to a system for reading vehicle accident information, and more particularly, to a system for reading vehicle accident information using a telematics system, in which circumstances of the vehicles involved in the accident are read when a vehicle owner causing the accident runs away from the accident site in which the owner of a damaged vehicle is not present where the accident takes place (e.g., a collision with a parked vehicle) as well as in a rear-end collision while driving on a road.

2. Description of the Related Art

Vehicle accidents are a common occurrence in many parts of the world, and the number of vehicle accidents increases each year with the increase of vehicles on the road. When a collision occurs while driving, the owners of accident-involved vehicles may occupy the road for hours to preserve evidence at the spot where the accident took place. As a result, traffic may be congested for a long time.

Generally, when dealing with the accident, the most important things are to evaluate which vehicle caused the accident and to quantify the degree of damage. When a collision occurs while driving, the subject vehicles move a distance from an initial accident site except for some specific cases. Unless speed marks are generated or witnesses from the collision scene are found, objective evidence is lost, and there will be continuing controversy over the circumstances of the accident. Therefore, insurance companies, the police, and the owners of the vehicles will be burdened with economical and time losses while determining the circumstances of the accident. Furthermore, in the case of a collision with a parked vehicle, unless the owner of a damaged vehicle or a witness is present on the site, it may be difficult to acquire accident information if the driver of the vehicle causing the collision does not get in touch with the owner of the damaged vehicle.

Therefore, it is preferred and required that the reasons of vehicle accidents be evaluated more objectively and more reasonably when such accidents occur while driving or the parking.

A system for objectively evaluating vehicular accident reasons is described in the Patent Laid Open Disclosure No. 2002-0067246, in which a sensor senses a collision and upon the generation of such a collision, generates electrical signals according thereto, and operates a solenoid valve mounted in an air tank so as to eject air and allow paint to be ejected on the ground through nozzles.

However, the above system has the disadvantages of replacing or managing the device periodically because the paint to be ejected upon the collision of vehicles is a volatile material that may easily harden at a low temperature or over a period of time. Also, the above system has disadvantages in that its components may become clogged, as, for example, the solenoid valve operating by the sensor to sense a collision, the air tank supplying air during the operation of the valve, and the spray nozzle for mixing paints contained in containers at the point of ejecting the paint. Furthermore, the paint contained in the containers may leak out of the vehicle even during slight collisions while the vehicle is parked, thus defacing the road.

### SUMMARY OF THE INVENTION

Accordingly, the present invention is directed to a system for reading vehicle accident information using a telematics system that substantially obviates one or more problems due to limitations and disadvantages of the related art.

An object of the present invention is to provide a system for reading vehicle accident information using a telematics system when a vehicle accident occurs while one vehicle is parked as well as when vehicles are driven.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a system for reading vehicle accident information using a telematics system of the present invention may include: a collision sensing unit operating when a collision of a greater intensity than a predetermined level occurs and outputting data according thereto; a video camera installed at the front or on the side of the vehicle, for photographing circumstances and subject vehicles involved in the collision; a speed detecting unit for detecting the speed of the vehicles and outputting data according thereto; a steering wheel information detecting unit for detecting steering wheel information of the vehicles; a telematics control unit for outputting information of the vehicle involved in the collision, which includes vehicle number, model and color and is sensed by the collision sensing unit, to the other vehicle involved in the collision, receiving vehicle information outputted from the other vehicle, storing the vehicle information in a data storing unit, calculating moving traces of the vehicles in a time period after the collision occurs and before the vehicles stop moving, by using the speed information, the steering wheel information of the vehicles and satellite communication information, and storing the moving traces of the vehicles in the data storing unit; an electronic map display unit for displaying current location of the vehicles; and a GPS data receiving/transmitting unit for transmitting the circumstances information of the vehicles, which is outputted by the telematics control unit when the collision occurs, to a service center and an insurance company.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawing, which is included to provide a further understanding of the invention and is incorporated in and constitutes a part of this application, illustrates embodiment(s) of the invention and together with the description serve to explain the principle of the invention. In the drawing:

FIG. 1 is a block diagram of a system for reading vehicle accident information using a telematics system of the present invention.

### DETAILED DESCRIPTION OF THE INVENTION

Reference will now be made in detail to the preferred embodiments of the present invention, examples of which are illustrated in the accompanying drawing. Wherever possible, the same reference numbers will be used throughout the drawing to refer to the same or like parts.

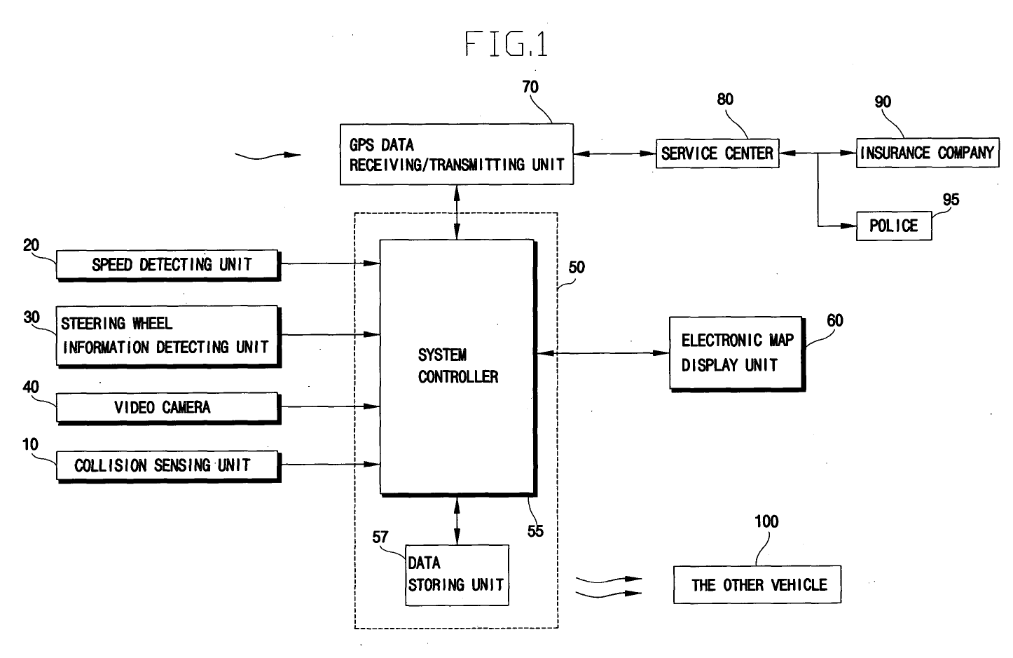

FIG. 1 is a block diagram of a system for reading vehicle accident information using a telematics system of the present invention. A collision sensing unit 10 is configured to operate when a collision of a greater intensity than a predetermined level occurs on a vehicle, and to provide the corresponding data according thereto to a system controller 55 of a telematics unit 50. A video camera 40 installed on the front or the side of the vehicle is configured to operate when the collision sensing unit 10 senses a collision upon its vehicle, to take pictures of the vehicles involved in the accident and the circumstances, and to record the data on a tape or memory device as recording medium. A speed detecting unit 20 detects the speed of the vehicle and outputs the data related thereto.

In the meantime, the telematics unit 50 is configured to provide each data outputted from a steering wheel information detecting unit 30 for detecting steering wheel information of the vehicle, the speed detecting unit 20, and the collision sensing unit 10 to the system controller 55 so as to transmit the information of the vehicle (vehicle number, model, color, etc.) to the other corresponding vehicle when a collision occurs. Also, the telematics unit 50 is configured to receive the vehicle information outputted from the other vehicle and stores the vehicle information data in a data storing unit 57. Furthermore, the telematics unit 50 is configured to calculate the moving traces of the other vehicle until it stops its moving after the accident occurs by using the speed information and steering wheel information of the vehicle and the satellite communication information, and to store the data in the data storing unit 57.

A GPS data receiving/transmitting unit 70 electrically connected with the telematics unit 50 is configured to receive/transmit the circumstances information of the vehicle outputted from the telematics unit 50 of the vehicle when the collision occurs to a service center 80, an insurance company 90, a police 95, and the like.

The system for reading vehicle accident information using a telematics system structured as above according to one embodiment of the present invention operates as follows.

When a collision of a greater intensity than a predetermined level occurs while driving or parking a vehicle employing the system for reading vehicle accident information of the present invention, the collision sensing unit 10 senses that collision, and provides accident information to the system controller 55 of the telematics unit 50.

The system controller 55 evaluates the input data, and transmits the vehicle information stored in the data storing unit 57 when a collision of a greater intensity than a predetermined level occurs, and concurrently receives and stores the vehicle information outputted from the telematics unit 100 of the other vehicle. At the same time, the system controller 55 takes samples of the speed information and the steering wheel information of the other vehicle in a predetermined period until the information from the other vehicle remains “0” for a time period after the accident occurs, and stores the samples in the data storing unit 57.

The telematics unit 50 also displays the current location of the vehicles in an electronic map display unit 60 by using the location information data received by the GPS data receiving/transmitting unit 70, and transmits the vehicle information data stored in the data storing unit 57 through the GPS data receiving/transmitting unit 70. Therefore, the service center 80, the insurance company 90, the police 95, and the like can take information about the vehicle accident and its reasons in real time.

Therefore, according to the present invention, circumstances of the vehicles involved in the accident are read in real time when a vehicle owner causing the accident runs away from the accident site in which the owner of a damaged vehicle is not present on the spot where the accident takes place (e.g., collision with a parked vehicle) as well as in a rear-end collision while the driving on the road.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for reading vehicle accident information using a telematics system, the reading system comprising:
a collision sensing unit operating when a collision of a greater intensity than a predetermined level occurs and outputting data according thereto;
a video camera installed at the front or on the side of the vehicle, for photographing circumstances and subject vehicles involved in the collision;
a speed detecting unit for detecting the speed of the vehicles and outputting data according thereto;
a steering wheel information detecting unit for detecting steering wheel information of the vehicles;
a telematics control unit for outputting information of the vehicle involved in the collision, which includes vehicle number, model and color and is sensed by the collision sensing unit, to the other vehicle involved in the collision, receiving vehicle information outputted from the other vehicle, storing the vehicle information in a data storing unit, calculating moving traces of the vehicles in a time period after the collision occurs and before the vehicles stop moving, by using the speed information, the steering wheel information of the vehicles and satellite communication information, and storing the moving traces of the vehicles in the data storing unit;
an electronic map display unit for displaying current location of the vehicles; and
a GPS data receiving/transmitting unit for transmitting the circumstances information of the vehicles, which is outputted by the telematics control unit when the collision occurs, to a service center and an insurance company.
